(19) United States
(12) Patent Application Publication
(10) Pub. No.: US 2015/0297030 A1
(43) Pub. Date: Oct. 22, 2015

(54) TOASTER USING THIN-FILM HEATING ELEMENT

(71) Applicant: Spectrum Brands, Inc., Middleton, WI (US)

(72) Inventors: David William Everett, JR., Verona, WI (US); Karl Warner Marschke, Madison, WI (US); Charles Nelson, Minneapolis, MN (US)

(21) Appl. No.: 14/688,699

(22) Filed: Apr. 16, 2015

Related U.S. Application Data
(60) Provisional application No. 61/980,468, filed on Apr. 16, 2014.
(60) Provisional application No. 62/040,213, filed on Aug. 21, 2014.

(51) Int. Cl. A47J 37/08; H05B 3/26; A23L 1/01

(52) U.S. Cl. CPC A47J 37/08; A23L 1/01; H05B 3/265; A23V 2002/00

(57) ABSTRACT

In a toaster and method for toasting a food product, the generally includes at least one thin-film heating element, the thin-film heating element including a resistive film coupled to a substrate and extending between a pair of electrical conductors.

### CROSS-REFERENCE TO RELATED APPLICATIONS

This application claims the benefit of U.S. Provisional Application No. 61/980,468 filed Apr. 16, 2014, and U.S. Provisional Application No. 62/040,213 filed Jul. 10, 2014, both of which are incorporated herein in their entirety.

### BACKGROUND

The present invention relates generally to toasters, and more particularly to toasters including one or more thin-film heating elements.

A toaster typically includes a housing that has at least one slot configured to receive a slice of bread or other food product to be toasted. A basket is disposed underneath each slot to retain the food product. When the toaster is activated, typically by depressing a vertical slider button, the food product is lowered within the basket into a heating box. In at least some known toasters, the heating box is located within about 6.35 mm (0.25 in.) of a base of the toaster to minimize a vertical profile of the toaster.

Within the heating box, heating units disposed on each side of the basket apply heat to the respective sides of the food product. At least some known toaster heating units utilize a filament wrapped around a heat-resistant board, wherein the filament radiates heat at infrared wavelengths when a current is applied to it. Typically, a control circuit determines the length of the heating operation based on a user control setting.

Satisfactory toasting of bread and other food products involves removing moisture from the food product. Because fresh bread and other fresh food products often contain a significant amount of moisture, satisfactory toasting traditionally has required several minutes of heating. Efforts to decrease the required heating time have been limited by several factors. For example, at least some known toaster heater units use iron-chromium filaments. However, iron-chromium tends to radiate in a portion of the infrared spectrum that is relatively inefficient at transferring energy to the food product.

Another factor is that in at least some known toasters, heat dissipates from the outside edges of the heating box more quickly than from the center. Thus, with regard to baskets adjacent to the outer wall of the toaster, the side of the food product facing the outer wall tends to brown more slowly than the side of the food product facing the interior of the toaster. This problem is exacerbated when the radiated power is increased in an attempt to speed the toasting process.

In addition, known attempts to decrease the time needed for satisfactory toasting have been limited by the fact that moisture released from the food product, in the form of water vapor (i.e. steam), absorbs a portion of the infrared radiation emanating from the heating unit throughout the toasting process. If more power is applied to the heating unit in an attempt to speed up the toasting process, correspondingly more steam is generated early in the process, thus absorbing more of the infrared radiation output from the heating unit and extending the process again.

There is a need, therefore, for an improved toaster with heating elements that are able to heat up and toast food products more quickly.

### SUMMARY

In one embodiment, a toaster generally comprises at least one thin-film heating element, the thin-film heating element including a resistive film coupled to a substrate and extending between a pair of electrical conductors.

In another embodiment, a method of toasting a food product generally comprises placing the food product in a toaster including at least one thin-film heating element, the thin-film heating element including a resistive film coupled to a substrate and extending between a pair of electrical conductors, and toasting the food product using the toaster.

### BRIEF DESCRIPTION

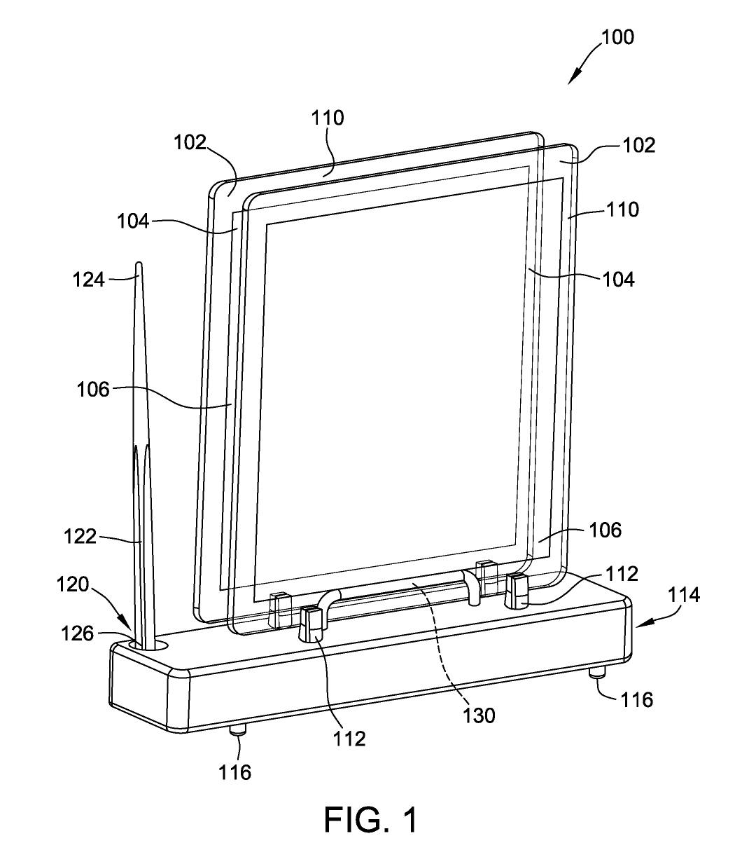

FIG. 1 is a perspective view of a toaster in accordance with one embodiment of the present disclosure;

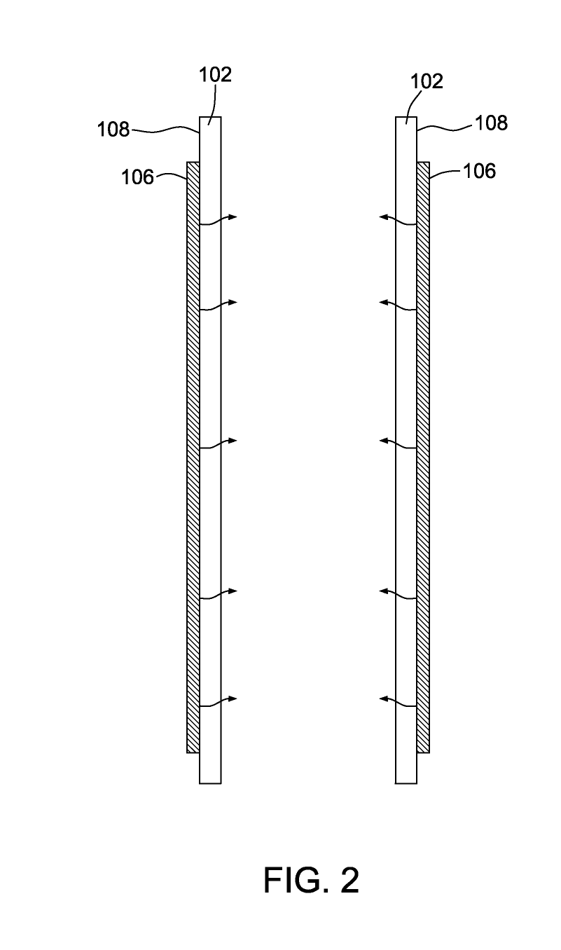

FIG. 2 is a schematic view of panels within the toaster of FIG. 1;

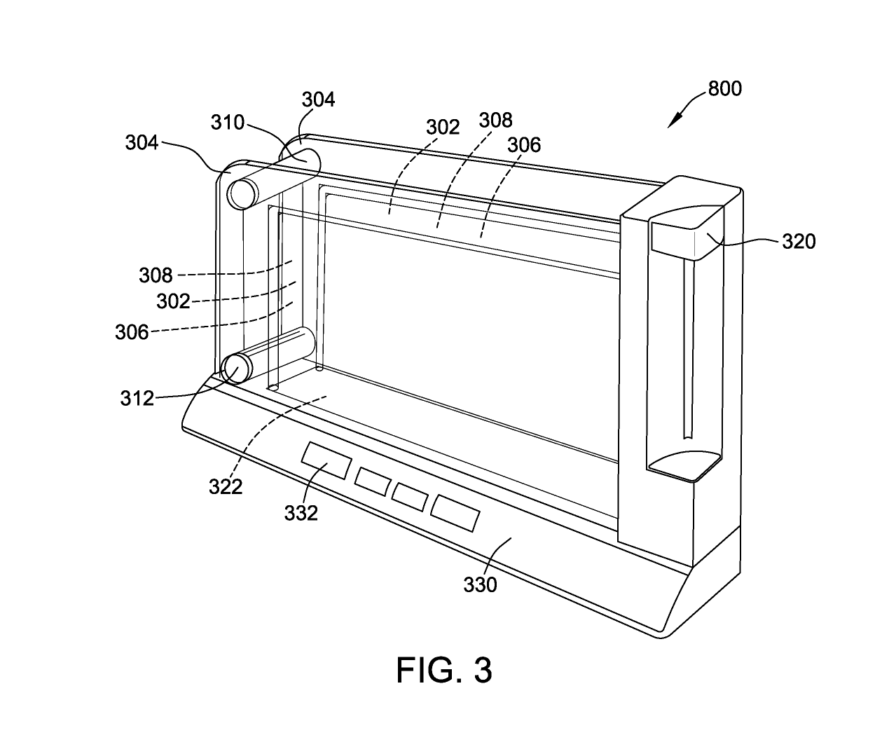

FIG. 3 is a perspective view of a toaster in accordance with another embodiment of the present disclosure;

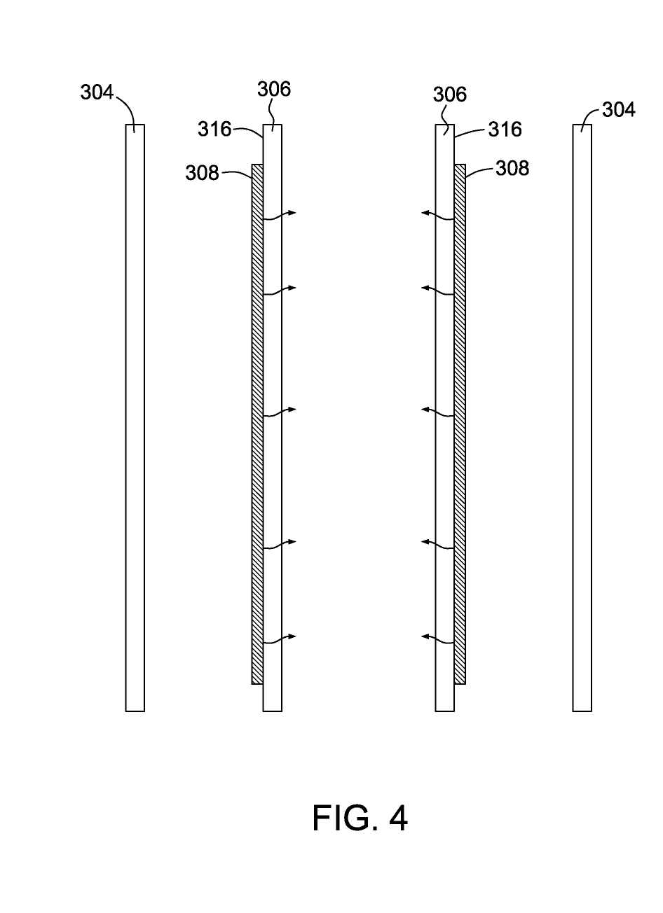

FIG. 4 is a schematic view of panels within the toaster of FIG. 3;

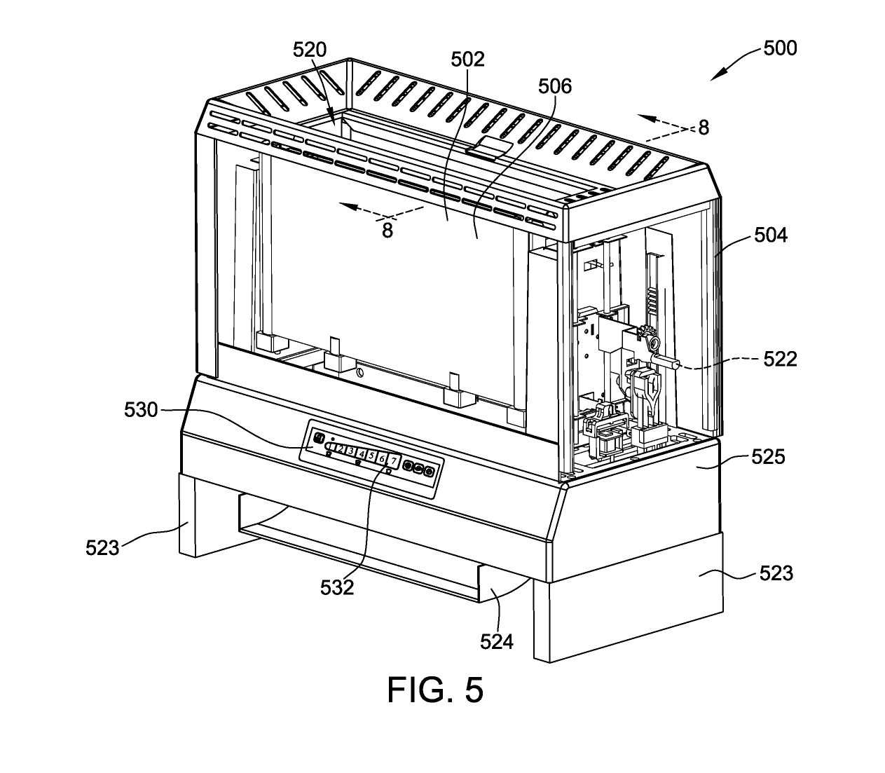

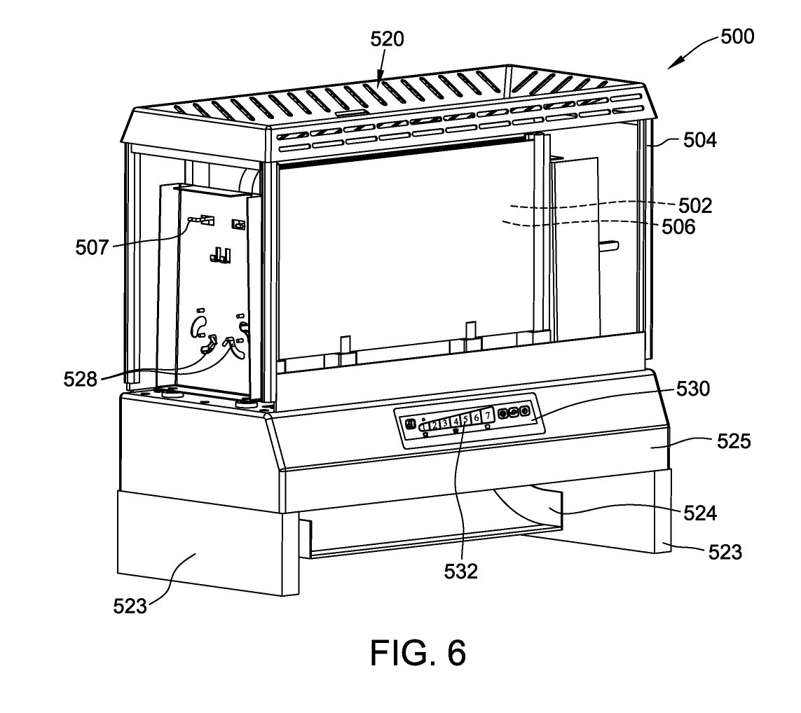

FIGS. 5-7 is are perspective views of a toaster in accordance with another embodiment of the present disclosure;

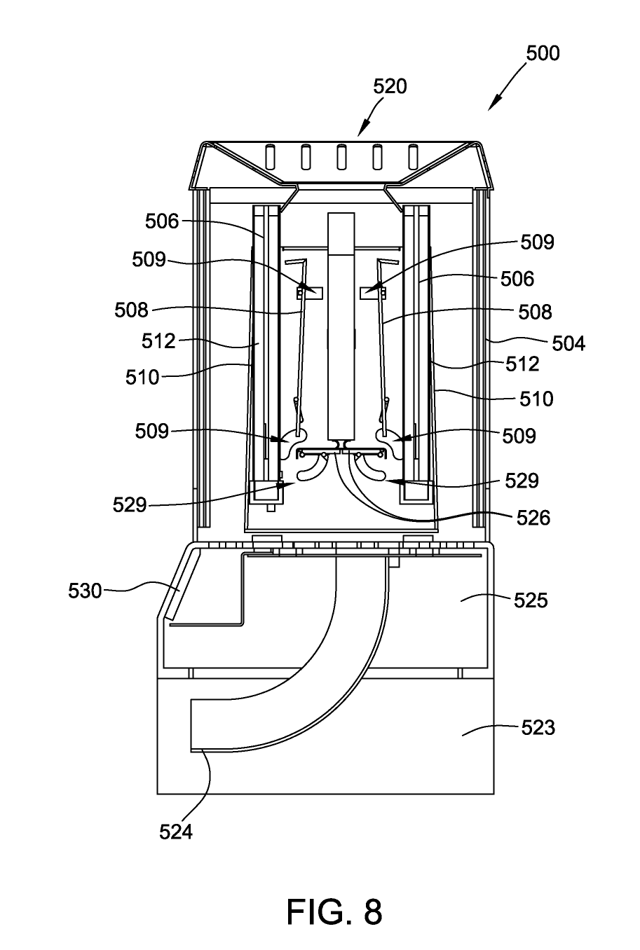

FIG. 8 is a cross-sectional view of the toaster of FIGS. 5-7 taken along line 8-8 (shown in FIG. 5);

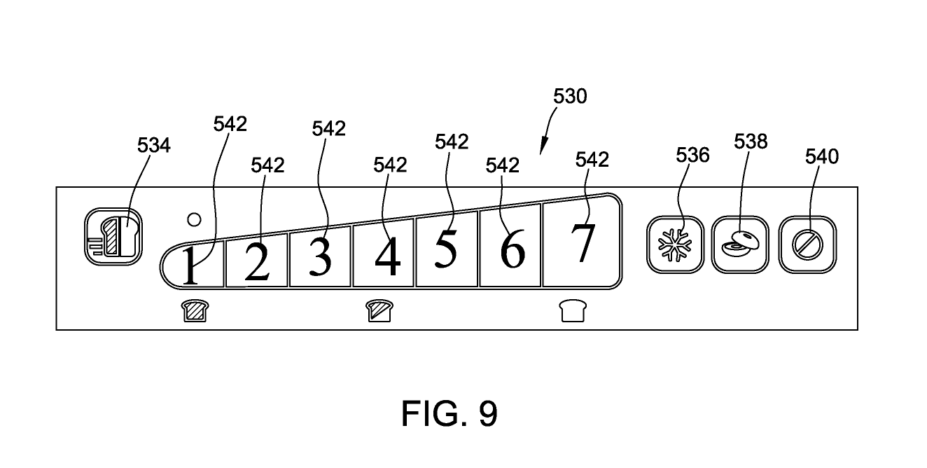

FIG. 9 is a schematic view of a control panel of the toaster of FIG. 5-7.

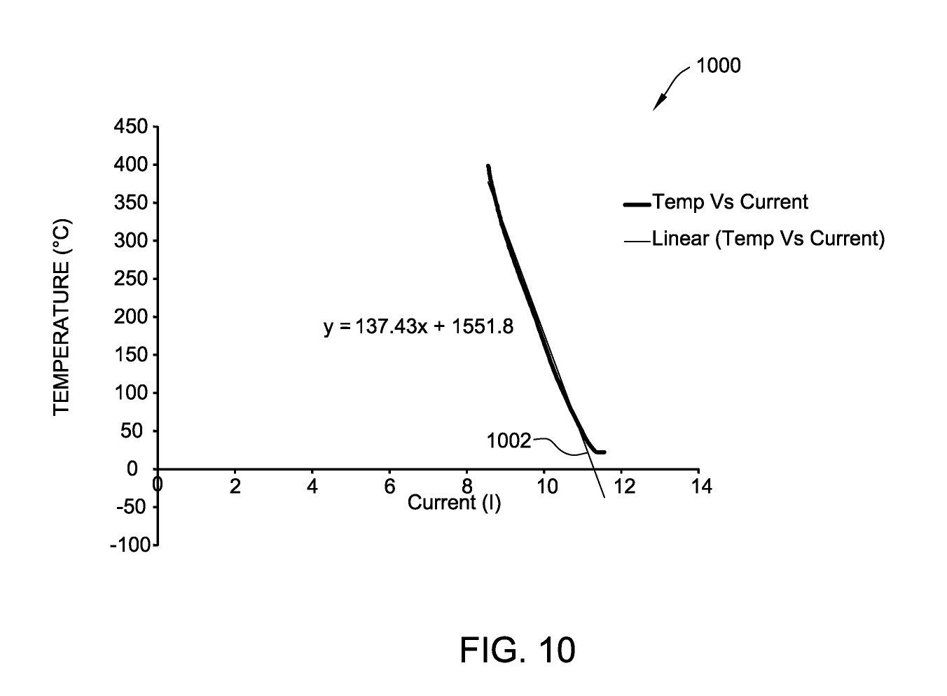

FIG. 10 is a graph showing a relationship between current and temperature.

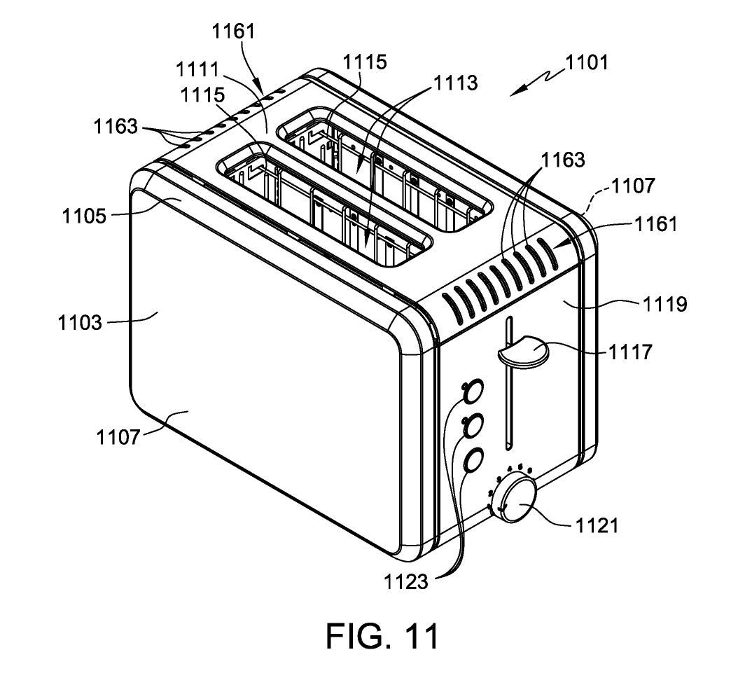

FIGS. 11-13 are perspective views of a toaster in accordance with another embodiment of the present disclosure;

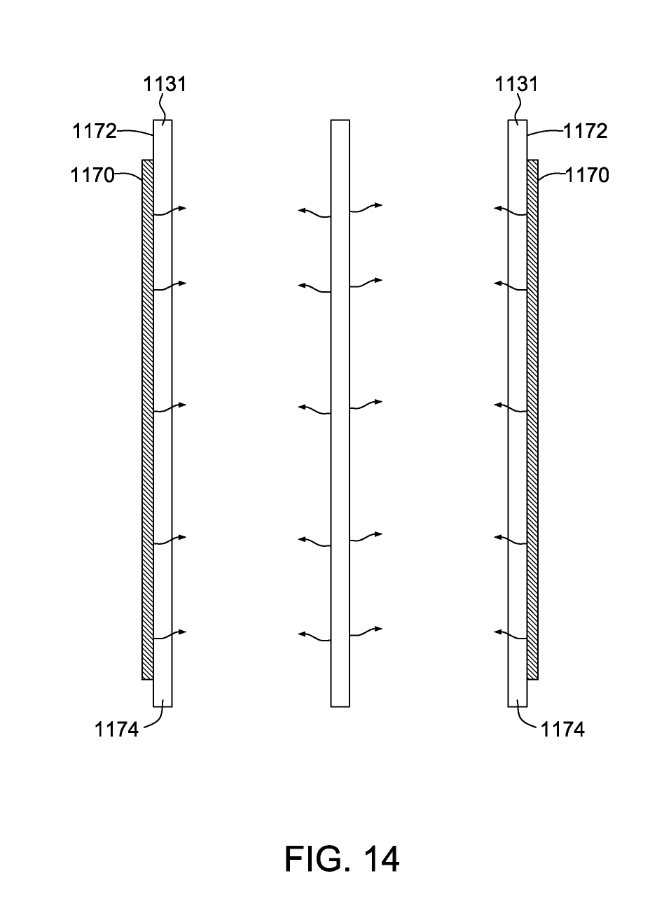

FIG. 14 is a schematic view of heating units within the toaster of FIGS. 11-13; and

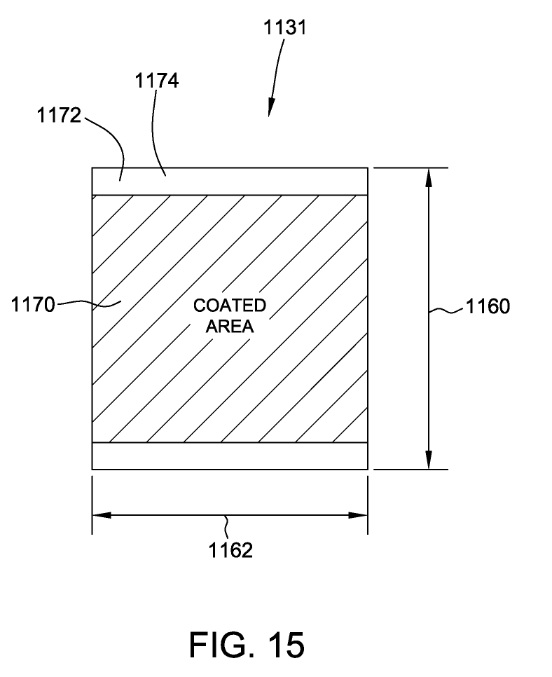

FIG. 15 is a schematic view of an outer heating unit within the toaster of FIGS. 11-13.

Corresponding reference characters indicate corresponding parts throughout the several views of the drawings.

### DETAILED DESCRIPTION

The systems and methods described herein employ a thin-film heating element as part of a toaster, such as a vertically-oriented bread toaster with the bread exiting from either the top or bottom of the toaster, a horizontally oriented toaster, and a single or multi-slice bread toaster (collected identified as a “toaster” herein). Integrating the thin-film heating element into the toaster creates unique aesthetic and functional design aspects.

The embodiments described herein include toasters including one or more thin-film heating elements. As used herein, a thin-film heating element refers to an electrically conductive material (e.g., a conductive film) deposited on a substrate (e.g., a ceramic glass substrate) for heating the substrate. The heating element is said to be a “thin-film” heating element in the sense that the substrate and the electrically conductive material have a collective thickness that is only marginally greater than the substrate itself (i.e., the material forms a thin film on the substrate).

The thin-film heating element may include, for example, a metal oxide (e.g., tin oxide) resistive film bounded on opposing edges by electrical conductors, such as electrical bus bars or wires. The bus bars or wires may connect to a controller and power source to run current through the resistive film to generate heat. Specifically, by applying a voltage between the bus bars or wires, current flows through the resistive film, heating the resistive film and the substrate on which the resistive film is deposited. Using a thin-film heating element improves power efficiency, heating uniformity, and speed of heating. Further, the thinness and conductive heat directionality of a thin-film heating element also permit a cooking appliance, such as a toaster, to have a thinner profile.

As described herein, in at least some embodiments, a toaster includes transparent windows (e.g., made of ceramic glass). The thin-film heating element may be combined with the transparent windows or on a separate substrate. In either case, the windows provide visual inspection of the toast being heated within the toaster.

With reference now to the drawings and in particular to FIG. 1, a toaster according to a first embodiment of the present disclosure is generally indicated at 100. The toaster 100 includes a pair of substantially transparent panels 102 spaced apart from each other. In this embodiment, the panels 102 are ceramic glass. Alternatively, the panels 102 may be made of any material that enables the toaster 100 to function as described herein.

As shown in FIG. 1, a thin-film heating element 104 is coupled to each panel 102. Each thin-film heating element 104 includes a resistive film 106 and bus bars or wires (neither shown) electrically coupled to the resistive film 106. Using the bus bars or wires, a current is run through the resistive film 106 to heat the resistive film 106 and consequently, the panel 102. The transparency of the thin-film heating elements 104 and the panels 102 allow a user to see through the toaster 100, and allow the user to observe a food product during toasting.

FIG. 2 is a schematic view of the panels 102 and the resistive films 106. As shown in FIG. 2, the resistive films 106 are located on an outer surface 108 of the panels 102. Running a current through the resistive films 106 causes heat to be emitted inward through the panels 102.

Referring back to FIG. 1, in this embodiment, the resistive film 106 covers only a portion of the outer surface 108 of the panel 102. That is, a perimeter 110 of the panel does not include resistive film 106. Accordingly, each panel 102 may be secured using a pair of brackets 112 made from a conductive material (e.g., metal). The brackets 112 extend upward from a base 114 of toaster. The panels 102 may be removably coupled to the brackets 112 (e.g., for cleaning purposes). A plurality of legs 116 extend downward from the base 114.

In this embodiment, the base 114 includes a tool slot 120 configured to store a toast removal tool 122 therein. Once bread is toasted in the toaster 100, a user can use the toast removal tool 122 to push toast out of the toaster 100. The toast removal tool 122 includes a pointed end 124 for contacting the toast and a handle end 126 sized to rest in the tool slot 120.

As shown in FIG. 1, the toaster 100 also includes a u-shaped toast support 130 that extends upward from the base 115. The toast support 130 contacts and supports a bottom edge of a piece of toast in the toaster 100 during toasting. Further, in this embodiment, the panels 102 are spaced such that the piece of toast contacts both panels 102 during toasting. Alternatively, the panels 102 may be spaced to facilitate minimal contact between the panels 102 and the piece of toast. The toaster 100 may have, for example, an operational voltage of approximately 220 VAC, with each thin-film heating element 104 having a maximum power of approximately 1200 Watts (W).

FIG. 3 is a perspective view of another embodiment of a toaster 300 that includes one or more thin-film heating elements 302. Specifically, toaster includes an outer pair of substantially transparent panels 304 and an inner pair of substantially transparent panels 306. In this embodiment, the inner panels 306 are spaced such that the piece of toast contacts both inner panels 306 during toasting. Alternatively, the inner panels 306 may be spaced to facilitate minimal contact between the inner panels 306 and the piece of toast. Further, in this embodiment, the outer panels 304 are tempered glass, and the inner panels 306 are ceramic glass. Alternatively, the outer and inner panels 304 and 306 may have any composition and configuration that enables the toaster 300 to function as described herein.

Each thin-film heating element 302 includes a resistive film 308 and bus bars or wires (neither shown) electrically coupled to the resistive film 308. Using the bus bars or wires, a current is run through the resistive film 308 to heat the resistive film 308 and consequently, the inner panel 306. Upper and lower support bars 310 and 312 extend between the outer panels 304. The transparency of the thin-film heating elements 302, the outer panels 304, and the inner panels 306 allow a user to see through the toaster 300, and allow the user to observe a food product during toasting.

FIG. 4 is a schematic view of the outer panels 304, the inner panels 306, and the resistive films 308. As shown in FIG. 2, the resistive films 308 are located on an outer surface 316 of the inner panels 306. Running a current through the resistive films 308 causes heat to be emitted inward through the inner panels 306. The outer panels 304 facilitate preventing a user from contacting the resistive films 308 and/or inner panels 306 during operation of the toaster 300.

Referring back to FIG. 3, the toaster 300 includes a lever 320 for lowering bread or other food products. Specifically, operating the lever 320 lowers a support tray 322 positioned between the two inner panels 306. In FIG. 3, Accordingly, to use the toaster 300, a food product is placed on the support tray 322 while the support tray is in a raised position (i.e., above or proximate a top of the inner panels 306), and the lever 320 is then operated to lower the support tray 322 and food product such that the food product is positioned between the inner panels 306. In FIG. 3, the support tray 322 is shown in the lowered position.

In this embodiment, the toaster 300 also includes a control panel 330 including one or more input interfaces 332 (e.g., buttons) that enable a user to control operation of the toaster. For example, the user may be able to specify a toasting time, a shade level, or other parameters. When the user sets a toasting time, once that toasting time is reached, the support tray 322 moves from the lowered position to the raised position, ejecting the food product from between the inner panels 306. In some embodiments, the control panel 330 includes an eject button that allows a user to eject the food product once the eject button is pressed, regardless of whether a previously set toasting time has been reached.

FIGS. 5-7 are perspective views of another embodiment of a toaster 500 that includes one or more thin-film heating elements 502. FIG. 8 is a cross-sectional view of the toaster 500 taken along line 8-8 (shown in FIG. 5). In this embodiment, toaster 500 is sized to hold two pieces of toast (positioned side by side) at a time.

The toaster 500 includes a substantially transparent outer casing 504 and a pair of substantially transparent panels 506. In this embodiment, as shown best in FIG. 8, the panels 506 are spaced such that the toast does not contact the panels 506. Further, the toaster 500 may include a pair of buffer frames 508 that prevent the toast from contacting the panels 506. Each buffer frame 508 may include one or more pins 507 that are guided by linear and/or arcuate grooves 509 to control a position of the buffer frame 508. In this embodiment, the casing 504 is tempered glass, and the panels 506 are ceramic glass. Alternatively, the casing 504 and the panels 506 may have any composition and configuration that enables the toaster 500 to function as described herein.

Each thin-film heating element 502 includes a resistive film 510 and bus bars or wires (neither shown) electrically coupled to the resistive film 510. Using the bus bars or wires, a current is run through the resistive film 308 to heat the resistive film 510 and consequently, the panel 506 that the resistive film 510 is coupled to. The transparency of the thin-film heating elements 502, the casing 504, and the panels 506 allow a user to see through the toaster 500, and allow the user to observe a food product during toasting.

As shown in FIG. 8, the resistive films 510 are located on an outer surface 512 of the panels 506. Running a current through the resistive films 510 causes heat to be emitted inward through the panels 506. The casing 504 facilitates preventing a user from contacting the resistive films 510 and/or panels 506 during operation of the toaster 500.

The toaster 500 includes an opening 520 at the top of the toaster 500 where the toast is inserted. A lever 522 allows a user to lower the toast into the toaster 500, similar to a conventional toaster. Once the toast is sufficiently heated within the toaster 500, the toast is released from the toaster 500 and slides out a chute 524 at the bottom of the toaster 500. Accordingly, if the user positions a plate in front of the chute 524, the dispensed toast will slide out of the chute 524 onto the plate. A pair of legs 523 extend downward from a base 525 of the toaster 500 to provide space for the chute 524.

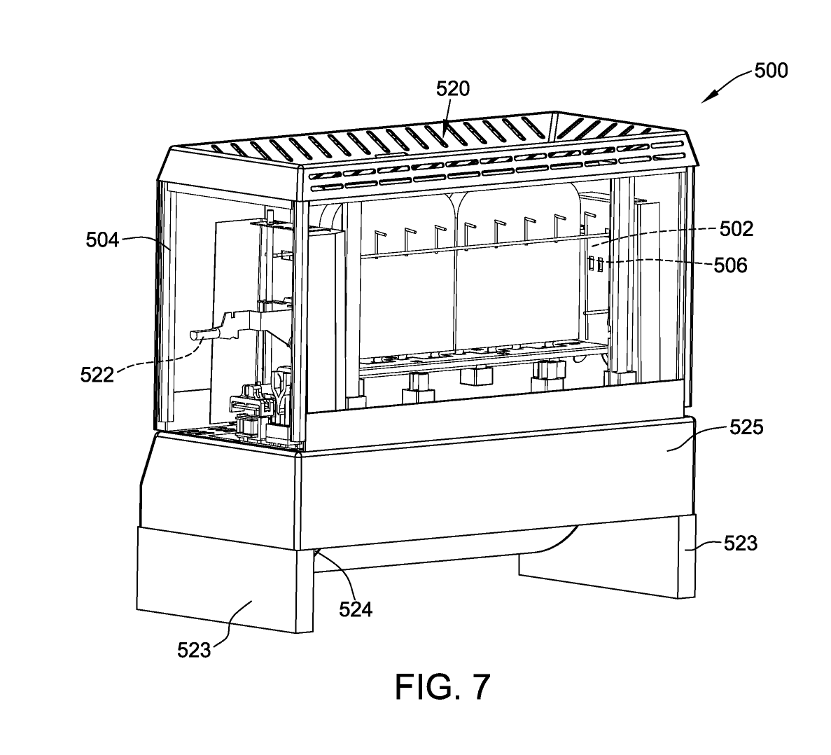

Specifically, as shown in FIG. 7, the toaster 500 includes a pair of trap doors 526. During toasting, the toast rests on the trap doors 526. Once toasting is complete, however, the trap doors 526 rotate downward and outward, causing the toast to fall into the chute 524. Specifically, each trap door 526 is coupled to an associated pin 528, and the pin 528 slides through an arcuate groove 529 to rotate the trap door 526 downward and outward. Dispensing finished toast using the chute 524 allows toast to be easily removed from the toaster 500 without requiring a user to place their hands or fingers near the thin-film heating elements 502, which may still be relatively hot.

In this embodiment, the toaster 500 also includes a control panel 530 (e.g., on the base 525) including one or more input interfaces 532 (e.g., buttons) that enable a user to control operation of the toaster. For example, the user may be able to specify a toasting time, a shade level, or other parameters. When the user sets a toasting time, once that toasting time is reached, the trap doors 526 open, dispensing the toast from the toaster 500. In some embodiments, the control panel 530 includes an eject button that allows a user to eject the toast once the eject button is pressed, regardless of whether a previously set toasting time has been reached.

FIG. 9 is a schematic view of one embodiment of the control panel 530. In the embodiment shown in FIG. 8, the control panel 530 includes a toasting mode button 534 (i.e., for toasting sliced bread), a defrost mode button 536 (i.e., for defrosting a food product), a bagel mode button 538 (i.e., for toasting a bagel), and an eject button 540 (i.e., for dispensing a food product from the toaster 500). When the toasting mode button 534 is selected, the user can select one of a plurality of present toasting configurations by pressing an associated configuration button 542. Each toasting configuration has an associated toasting time and desired shade level.

In this embodiment, the toaster 500 includes a temperature control system. Notably, it has been experimentally verified that there is a substantially linear relationship between a current conducted through a thin-film heating element 502 and a temperature of the thin-film heating element 502. FIG. 10 is a graph 1000 showing measured values of temperature versus current, and a linear fit 1002 approximating a linear relationship between the measured values and generated based on the measured values.

Accordingly, by measuring the current conducted through the thin-film heating element 502, the approximate temperature of the thin-film heating element 502 can be calculated using the linear fit 1002 and the measured current. In this embodiment, a resistor is electrically coupled in series with each thin-film heating element 502. By dividing a voltage across the resistor by a resistance value of the resistor, the current through the associated thin-film heating element 502 can be measured.

In this embodiment, the temperature control system can be implemented using a microcontroller (not shown) included within the toaster 500. Specifically, for each thin-film heating element 502, the microcontroller divides the voltage across the resistor by the resistance value of the resistor to calculate the measured current, and calculates the approximate temperature based on the linear relationship and the measured current.

The microcontroller may, for example, control the current through each thin-film heating element 502 to control the temperature of the thin-film heating element 502. In one example, the microcontroller ensures that a temperature of each thin-film heating element 502 does not exceed a predetermined maximum temperature (e.g., 400° Celsius). Specifically, when the approximate temperature calculated by the microcontroller reaches or approaches the predetermined maximum temperature, the microcontroller decreases the current through the thin-film heating element 502 (e.g., by decreasing the applied voltage) such that the approximate temperature is reduced. In this embodiment, the average voltage is decreased. Specifically, a peak voltage level remains the same, but the number of cycles during which the peak voltage level is applied is reduced. Accordingly, over a period of time, the average voltage (and accordingly, the average current) is reduced.

FIG. 11 is a perspective view of another embodiment of a toaster 1101 that includes one or more thin-film heating elements. The toaster 1101 generally includes a housing 1103 having an upper housing portion 1105 and two generally oppositely disposed side surfaces 1107. A plurality of slots 1113 are located on a top surface 1111 of the upper housing portion 1105. Each slot 1113 is configured to receive a slice of bread or other food product (not shown) to be toasted. While two slots 1113 are shown in the embodiment illustrated in FIG. 11, it should be understood that in alternative embodiments, the toaster 1101 may have one, three, four, or any suitable number of slots 1113.

A basket 1115 is disposed generally underneath each slot 1113 within housing 1103. Each basket 1115 is configured to receive the food product through the corresponding slot 1113 and retain the received food product in position during the toasting process. In addition, a vertical slider button 1117 is disposed on a front surface 1119 of the housing 1103. The button 1117 is operably coupled to each basket 1115 in conventional fashion. More specifically, when the button 1117 is depressed, the received food product (not shown) is lowered within each basket 1115 such that substantially all of the received food product is disposed within the housing 1103. The button 1117 may be coupled to the baskets 1115 in any suitable fashion. In alternative embodiments, any suitable control may be used to lower the received food product within each basket 1115.

In the illustrated embodiment, a browning control selector 1121 and a plurality of user buttons 1123 also are disposed on front surface 1119. The browning control selector 1121 is configured in conventional fashion to enable a user to select a desired degree of toasting (i.e., corresponding to a desired shading) to be performed. The user buttons 1123 are configured in conventional fashion to allow the user to control other toaster functions, for example, identifying a type of food product (e.g. bread, bagel, etc.) to enable optimization of the toasting process, popping the food product within each basket 1115 up through the corresponding slot 1113 and manually ending the toasting process, etc. In alternative embodiments, the toaster 1101 may have a plurality of vertical slider buttons 1117, browning control selectors 1121, and sets of user buttons 1123 each associated with a subset of the slots 1113.

At least one vent 1161 is disposed on the upper housing portion 1105 of the toaster 1101. In the illustrated embodiment, a vent 1161 is disposed near each respective opposite end of the top surface 1111 of the housing 1103. Each vent 1161 includes a plurality of elongated openings 1163 extending through the housing 1103. The vents 1161 facilitate air circulation through the interior of the housing 1103.

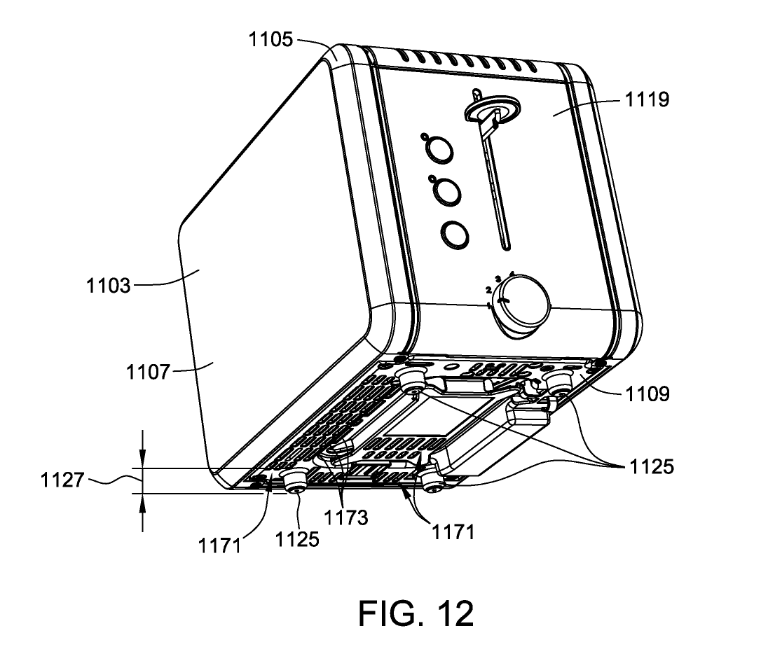

Referring now in particular to FIG. 12, the housing 1103 is coupled to a base 1109. The base 1109 includes a plurality of legs 1125 configured to support the toaster 1101 on a countertop or other suitable generally smooth surface (not shown). The legs 1125 each have a length 1127 that is sufficiently long such that a gap exists between the base 1109 and the generally smooth surface upon which the legs 1125 rest. Moreover, at least one vent 1171 is disposed on the base 1109. In this embodiment, a plurality of vents 1171 are disposed on the base 1109. Each vent 1171 includes a plurality of elongated openings 1173 extending through the base 1109. The base vents 1171 cooperate with the upper housing vents 1161 to facilitate air circulation through the interior of the housing 1103.

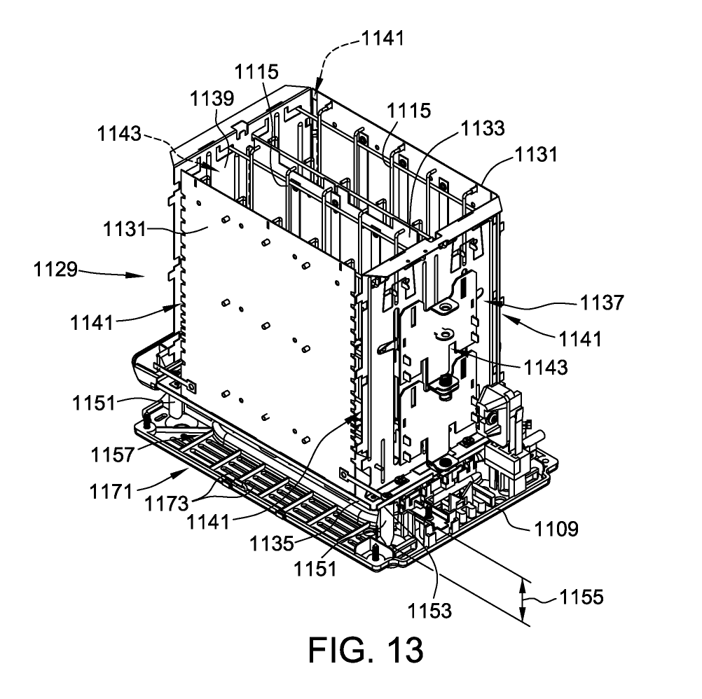

FIG. 13 illustrates an embodiment of the interior of the toaster 1101 with housing 1103 removed. A heating box 1129 is defined by two outer heating units 1131, a bottom plate 1135, a front plate 1137, and a back plate 1139. Each outer heating unit 1131 is coupled to the bottom plate 1135 using any suitable fasteners. Additionally or alternatively, each outer heating unit 1131 may be coupled to at least one of the front plate 1137 and the back plate 1139. In this embodiment, each outer heating unit 1131 includes a thin-film heating element 1132, similar to those described above.

In this embodiment, the two outer heating units 1131, the bottom plate 1135, the front plate 1137, and the back plate 1139 are configured such that the side surfaces of the heating box 1129 are not sealed. More specifically, apertures 1141 are present between each outer heating unit 1131 and the front plate 1137, and between each outer heating unit 1131 and the back plate 1139.

Additionally or alternatively, apertures 1143 are defined in the front plate 1137 and the back plate 1139.

In this embodiment, the heating box 1129 is coupled to the base 1109 of the toaster 1101. More specifically, a plurality of posts 1151 extend upward from the base 1109 and couple to the bottom plate 1135 of the heating box 1129. Each post 1151 is coupled to the base 1109 and to the bottom plate 1135 using a suitable fastening structure. A washer 1153 formed from a suitable insulating material, such as, but not limited to, mica, is disposed between each post 1151 and the bottom plate 1135 to facilitate insulating the heating box 1129 from the base 1109.

In the illustrated embodiment, a length 1155 of the posts 1151 is extended beyond a minimum length required for insulation purposes. Due to the extended length 1155, a cavity 1157 is defined between the bottom plate 1135 and the base 1109. The cavity 1157 facilitates airflow through the interior of the housing 1103. In another embodiment, the length 1155 is in a range of about 12.7 mm (0.5 in.) to about 15.875 mm (0.625 in.). In another embodiment, the length 1155 is about 12.7 mm (0.5 in.).

An inner heating unit 1133 is disposed within heating box 1129 between the adjacent pair of baskets 1115. The inner heating unit 1133 is coupled to at least one of the bottom plate 1135, the front plate 1137, and the back plate 1139. In this embodiment, the inner heating unit 1133 does not include a thin-film heating element. Instead, the inner heating unit 1133 includes a board formed from a suitably heat-resistant material, such as mica, with a pattern of wire filament disposed on both sides of the board. In FIG. 13, the wire filaments are omitted for ease of viewing.

With reference to FIGS. 11-13, in the illustrated embodiment, the vertical slider button 1117 is configured to activate heating units 1131 and 1133 in conventional fashion when vertical slider button 1117 is depressed. Moreover, the browning control selector 1121 and the plurality of user buttons 1123 are operatively coupled to heating units 1131 and 1133 in conventional fashion to facilitate controlling a power and duration of the toasting process. For example, the vertical slider button 1117, the browning control selector 1121, and the plurality of user buttons 1123 may be electronically coupled as inputs to one or more printed circuit boards (not shown) disposed in the housing 1103, and the printed circuit boards may include one or more control circuits or processors configured to control a power supplied to each of heating units 1131 and 1133, thereby controlling the power and duration of the toasting process.

FIG. 14 is a schematic view of the outer heating units 1131 and the inner heating unit 1133. As shown in FIG. 14, the outer heating units 1131 each include a resistive film 1170 applied to an outer surface 1172 of a substrate 1174. Running a current through the resistive films 1170 causes heat to be emitted inward through the substrates 1174. Heat generated by the inner heating unit 1133 is emitted in both directions, as shown in FIG. 14. In some embodiments, the outer heating units 1131, the inner heating unit 1133, and at least a portion of the housing 1103 are substantially transparent, allowing a user to see through the toaster 1100, and allow the user to observe a food product during toasting. The outer heating units 1131 and the inner heating unit 1133 may be electrically coupled in parallel or in series.

FIG. 15 is a schematic view of one outer heating unit 1131. As shown in FIG. 15, the resistive film 1170 is only applied to a portion of the outer surface 1172 of the substrate 1174. For example, if the substrate 1174 unit 1131 has a height 1160 of approximately six inches, and a width 1162 of approximately five inches, upper and lower portions of the substrate 1174 having dimensions approximately one-half inch by five inches may remain uncoated with the resistive film 1170. Accordingly, the outer heating unit 1131 may be held, for example, with brackets made of a conductive material (e.g., metal) that contact the uncoated portions of the substrate 1174. The toaster 1100 may have, for example, an operational voltage of approximately 220 VAC, with each thin-film heating element 1132 having a maximum power of approximately 1200 Watts (W).

In some embodiments, a user may control toasters 100, 300, 500, and 1100 using a computing device (e.g., a tablet, a desktop computer, a laptop computer, a mobile phone, etc.), where the computing device communicates remotely with the toaster over a wired and/or wireless network, such as the Internet, or any other communications medium (e.g., Bluetooth®). For example, the user may use a software application on a computing device that enables the user to set a toasting time, where the input is communicated from the computing device to the toaster. Further, the toaster may communicate information to the computing device (e.g., remaining toasting time) to notify the user.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A toaster comprising at least one thin-film heating element, the thin-film heating element comprising a resistive film coupled to a substrate and extending between a pair of electrical conductors.

2. The toaster of claim 1, wherein the substrate is a substantially transparent substrate.

3. The toaster of claim 1, wherein the substrate is ceramic glass.

4. The toaster of claim 1, wherein the at least one thin-film heating element comprises a first thin-film heating element and a second thin-film heating element in a spaced relationship with the first thin-film heating element.

5. The toaster of claim 4, further comprising an additional heating element positioned between the first thin-film heating element and the second thin-film heating element.

6. The toaster of claim 5, wherein the additional heating element comprises a mica board with a pattern of wire filament disposed thereon.

7. The toaster of claim 1, further comprising a temperature control system coupled to the at least one thin-film heating element, the temperature control system configured to:
calculate an approximate temperature of the at least one thin-film heating element; and
control the at least one thin-film heating element based on the calculated approximate temperature.

8. The toaster of claim 7, wherein to calculate an approximate temperature, the temperature control system is configured to calculate the approximate temperature by:
measuring a current flowing through the at least one thin-film heating element; and
calculating the approximate temperature based on the measured current.

9. The toaster of claim 7, wherein to control the at least one thin-film heating element, the temperature control system is configured to adjust a voltage across the at least one thin-film heating element to prevent the approximate temperature from exceeding a predetermined temperature.

10. The toaster of claim 1, further comprising a chute positioned below the at least one thin-film heating element, wherein the chute is configured to dispense a food product from the toaster.

11. A method of toasting a food product, the method comprising:
placing the food product in a toaster including at least one thin-film heating element, the thin-film heating element including a resistive film coupled to a substrate and extending between a pair of electrical conductors; and
toasting the food product using the toaster.

12. The method of claim 11, wherein placing the food product in a toaster comprises placing the food product in a toaster in which the substrate is a substantially transparent substrate.

13. The method of claim 11, wherein placing the food product in a toaster comprises placing the food product in a toaster in which the substrate is ceramic glass.

14. The method of claim 11, wherein placing the food product in a toaster comprises placing the food product in a toaster in which the at least one thin-film heating element includes a first thin-film heating element and a second thin-film heating element in a spaced relationship with the first thin-film heating element.

15. The method of claim 14, wherein placing the food product in a toaster comprises placing the food product in a toaster that further includes an additional heating element positioned between the first thin-film heating element and the second thin-film heating element.

16. The method of claim 15, wherein the additional heating element includes a mica board with a pattern of wire filament disposed thereon.

17. The method of claim 11, further comprising:
calculating, using a temperature control system, an approximate temperature of the at least one thin-film heating element; and
controlling, using the temperature control system, the at least one thin-film heating element based on the calculated approximate temperature.

18. The method of claim 17, wherein calculating an approximate temperature comprises calculating the approximate temperature by:
measuring a current flowing through the at least one thin-film heating element; and
calculating the approximate temperature based on the measured current.

19. The method of claim 17, wherein controlling the at least one thin-film heating element comprises adjusting a voltage across the at least one thin-film heating element to prevent the approximate temperature from exceeding a predetermined temperature.

20. The method of claim 11, further comprising dispensing the toasted food product from the toaster using a chute positioned below the at least one thin-film heating element.
